(19) United States
(12) Patent Application Publication
(10) Pub. No.: US 2010/0120298 A1
(43) Pub. Date: May 13, 2010

(54) TERMINAL FITTING A WIRE CONNECTION STRUCTURE AND A CONNECTING METHOD

(75) Inventor: Yukiko Eba, Yokkaichi-City (JP)

Correspondence Address: CASELLA & HESPOS, 274 MADISON AVENUE, NEW YORK, NY, 10016, US

(73) Assignee: SUMITOMO WIRING SYSTEMS, LTD., Yokkaichi-City (JP)

(21) Appl. No.: 12/613,127

(22) Filed: Nov. 5, 2009

(30) Foreign Application Priority Data
Nov. 12, 2008 (JP) 2008-290199

(51) Int. Cl. H01R 13/415

(52) U.S. Cl. 439/741

(57) ABSTRACT

A connection structure and terminal fitting are provided for suppressing the height of a deformed front end portion of a conductor. The connection structure and terminal fitting include a wire barrel (25), in which a pair of crimping pieces (27) stand up from a bottom wall (26), and a wire (10), including a conductor (11) formed by twisting a plurality of metal thin wires. The crimping pieces (27) in the wire barrel (25) compress the conductor (11) while surrounding it to electrically connect the conductor (11). The front end of the conductor projects forward from the front end of the wire barrel. Pressing portions (29) closer to the bottom wall (26) than rear end areas of the crimping pieces (27) are formed in the front ends of the upper walls (28) of the crimping pieces (27) at a side of the conductor (11) opposite to the bottom wall (26).

### BACKGROUND OF THE INVENTION

1. Field of the Invention

The present invention relates to a terminal fitting and a wire connection structure and to a connecting method therefor.

2. Description of the Related Art

Japanese Unexamined Patent Publication No. 2005-222815 discloses a structure for connecting a terminal fitting. The terminal fitting includes a wire barrel in the form of an open barrel, in which a pair of crimping pieces stand up from the opposite left and right edges of a bottom wall. The structure also includes a front end portion of a wire including a conductor formed by twisting a plurality of metal thin wires. In the wire barrel portion, the crimping pieces of the wire barrel surround and compress the conductor so that whereby the wire is electrically connected. In a connected state, a front end portion of the conductor projects forward from the front end of the wire barrel portion.

An oxide film will form if the conductor in the wire is made of aluminum. Thus, the wire barrel must be fastened more tightly to remove an oxide film. However, if the wire barrel portion is fastened more tightly, the metal thin wires constituting the conductor will loosen and deform during the crimping process. Some of the spread metal thin wires will bend toward a side opposite to the bottom wall. These bent-up metal thin wires may interfere with other members.

The present invention was developed to suppress or reduce the formation of a bent-up front end portion of a conductor projecting from a wire barrel portion.

### SUMMARY OF THE INVENTION

The subject invention relates to a connection structure for a terminal fitting, with a wire barrel portion in the form of at least one open barrel, in which one or more, and, preferably a pair, of crimping pieces project from a base wall. The crimping pieces compress a conductor of a wire while at least partly surrounding the conductor in the wire barrel portion to electrically connect the conductor. A front end portion of the conductor projects forward from the front end of the wire barrel in a crimped state. One or more pressing portions are formed in or near one or more front end portions of one or more ceiling walls of the crimping pieces located at a side of the conductor substantially opposite to the base wall. The pressing portions are closer to the base wall than rear end areas of the crimping pieces.

The height of the front end portion of the conductor projecting from the front end of the wire barrel from the base wall is reduced due to the displacement of the conductor toward the base wall. Thus, even if the metal thin wires are deformed by the crimping, the height of the bent-up portions of the conductor will be reduced or suppressed.

The pressing portions at the front end of the upper walls of the crimping pieces are inclined to approach the base or bottom wall toward the front. As a result, the front end portion of the conductor also projects toward the base or bottom wall from the front end of the wire barrel. Thus, the height of the deformed front end portion of the conductor can be suppressed more effectively.

The angle of inclination of the pressing portions preferably is substantially constant over the entire lengths of the pressing portions.

Still further preferably, the pressing portions are formed into recesses by hammering parts of the upper walls of the crimping pieces except the opposite widthwise end portions toward the bottom wall, and the opposite widthwise end portions of the front end portions of the upper walls are formed into folded portions projecting toward a side opposite to the bottom wall.

If the front end portions of the upper walls of the crimping pieces are deformed over the entire widths to approach the bottom wall upon forming the pressing portions, side walls connecting the upper walls and the bottom wall are deformed outwardly in the width direction by as much as the approach amount of the upper walls toward the bottom wall and the wire barrel portion is widened. In contrast, the folded portions are formed at the opposite widthwise end portions of the upper walls in the present invention and only the parts between the folded portions are formed into the pressing portions by being deformed to approach the bottom wall. Thus, the side walls will not be displaced.

The pair of lateral crimping pieces preferably are laterally symmetric.

Preferably, one pressing portion is individually formed at each crimping piece of the plurality of crimping pieces.

Most preferably, the rear end areas of the crimping pieces behind or adjacent to the pressing portions are substantially parallel to the base wall.

The invention also relates to a terminal fitting comprising the above described connection structure and a terminal connecting portion substantially continuous thereto.

These and other objects, features and advantages of the present invention will become more apparent upon reading the following detailed description of preferred embodiments and accompanying drawings. It should be understood that even though embodiments are separately described, single features thereof may be combined to create additional embodiments.

### BRIEF DESCRIPTION OF THE DRAWINGS

FIG. 1 is a side view of one embodiment.

FIG. 2 is a plan view of the embodiment.

FIG. 3 is a section along X-X of FIG. 1 without any graphical representation of a conductor of a wire.

FIG. 4 is a partial enlarged section showing a state where pressing portions are pressing the conductor obliquely downward toward the front.

### DETAILED DESCRIPTION OF THE PREFERRED EMBODIMENTS

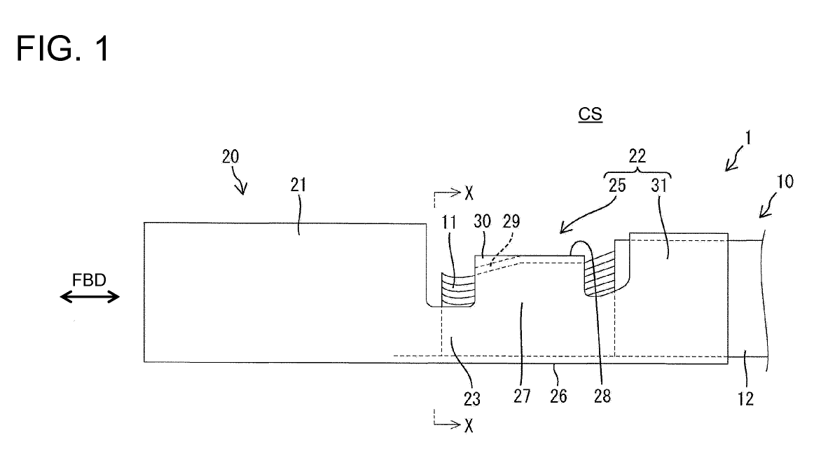

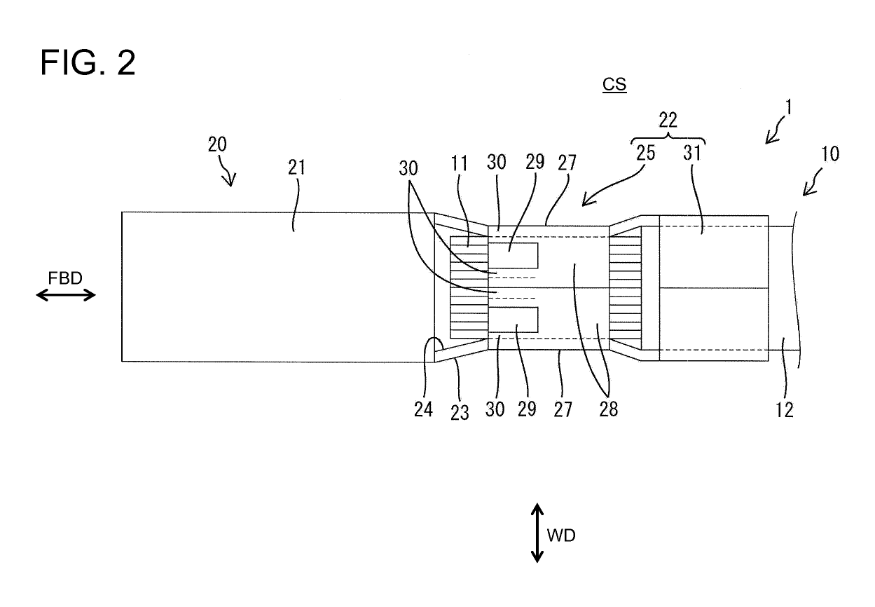

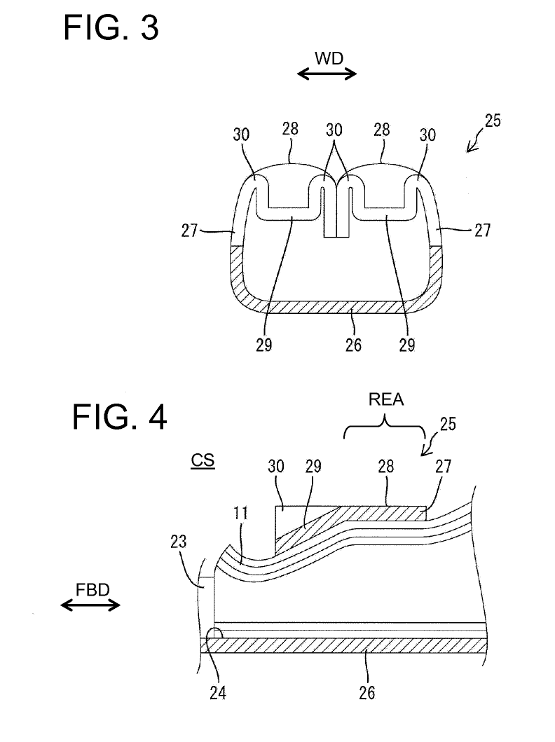

A conduction path in accordance with the invention is identified by the numeral 1 in FIGS. 1 and 2. The conduction path 1 is formed by connecting a front end portion (left end portion in FIGS. 1 and 2) of a wire 10 with a crimping portion 22 (as a preferred connecting structure) formed at or near a rear end portion of a terminal fitting 20.

The wire 10 is comprised of a conductor 11 formed by twisting a plurality of metal thin wires and an insulation coating 12 at least partly surrounding the conductor 11. In the front end portion of the wire 10, the insulation coating 12 is partly removed in preparation for connection with the terminal fitting 20, whereby a front end portion of the conductor 11 is exposed. Copper or copper alloy, a material having higher rigidity than copper or copper alloy (e.g. aluminum or aluminum alloy) and/or a material having lower electrical conductivity than copper or copper alloy (e.g. aluminum or aluminum alloy) is or may be used as the material for the conductor 11.

The terminal fitting 20 is a female terminal fitting formed by applying, bending, folding, and/or embossing and the like to a conductive (preferably metal) plate material punched or cut out into a specified shape, wherein a front end region serves as a terminal connecting portion 21 in the form of a rectangular tube and a rear end region serves as a crimping portion 22 in the form of at least one open barrel. The terminal connecting portion 21 is of the known form that functions as connection means with a narrow and long tab (not shown) formed on a mating male terminal. It should be understood, however, that the present invention is also applicable to male terminal fittings having a substantially tab-shaped terminal connection portion connectable to a mating female terminal.

The rear end of the terminal connecting portion 21 and the front end of the crimping portion 2 are coupled via at least one coupling portion 23. The coupling portion 23 includes a lower or base plate and two laterally symmetrical side plates or projecting at an angle, preferably substantially at right angles from the lateral edges of the lower plate. Thus, an accommodation space 24 with a substantially open upper side is formed in the coupling portion 23.

The crimping portion 22 includes at least one wire barrel 25 substantially continuous with the rear end of the coupling portion 23 and at least one insulation barrel 31 located behind the wire barrel 25. The insulation barrel 31 is to be crimped, bent, or folded into connection with a part of the front end of the wire 10 where the insulation coating 12 at least partly surrounding the conductor 11 is provided or still remains. Upon the crimping operation, an automatic machine (not shown) called an applicator is used and the insulation barrel 31 is crimped, bent, or folded into connection with the wire 10 at the same time that the wire barrel 25 is crimped or bent or folded into connection with the conductor 11. In the crimped state, the wire 10 is pressed over the entire circumference by the insulation barrel 31 and the wire 10 is fixed to the insulation barrel 31 by this pressing.

The wire barrel 25 includes a bottom or base wall 26 substantially continuous with the lower plate of the coupling portion 23 and a pair of laterally symmetrical crimping pieces 27 extending from the lateral edge(s) of the bottom wall 26. This wire barrel 25 is to be crimped, bent, or folded into electrical connection with the front end of the conductor 11 partially exposed by removing the insulation coating 12 near the front of the wire 11, so that the conductor 11 is fixed. Upon performing the crimping operation, the crimping portion 22 set in an anvil (not shown) of the automatic machine and the conductor 11 placed on the bottom wall 26. A crimper (not shown) then is lowered to deform the crimping piece(s) 27 to wind them at least partly around the conductor 11 The bottom wall 26 and the pair of crimping pieces 27 are so crimped, bent, or folded so as to at least partly surround the conductor 11 while pressing it.

In the crimped state, the front end of the conductor 11 projects forward from the front end edge(s) of the crimping piece(s) 27 (wire barrel portion 25) and at least partly contained in the accommodation space 24 enclosed or defined by the lower or base plate and the opposite side plates of the coupling portion 23. If the conductor 11 is made of aluminum or aluminum alloy, the wire barrel 25 is strongly fastened during the crimping operation to remove oxide films on the outer surfaces of the conductor (preferably of the metal thin wires). In this case, the metal thin wires of the conductor 11 may be loosened and front end portions of the loosened metal thin wires are or may be deformed to spread out in the accommodation space 24 before the wire barrel 24. The accommodation space 24 is open upward, thus, some of the metal thin wires may be bent to be located above the wire barrel 25. If a part above the accommodation space 24 serves as a space to arrange another member (e.g. a retainer for retaining the terminal fitting 20 by being engaged with the rear end edge of the terminal connecting portion 21 when the terminal fitting 20 is inserted into an unillustrated housing), the bent-up metal thin wires may interfere with the other member. Furthermore, the outwardly projecting part of the conductor may also interfere with an outside member such as a housing upon being inserted therein.

The wire barrel 25 is formed with one or more pressing portions 29 as means for preventing the front end of the conductor 11, and specifically the metal thin wires of the conductor 11, from being bent toward the upper side. The pressing portions 29 are formed at or on one or more upper walls 28 of the crimping pieces 27 to be located at a side of the conductor 11 substantially opposite to the bottom wall 26 in the crimped state CS. The pressing portions 29 are formed by hammering after the wire barrel portion 25 is crimped or bent or folded into connection with the conductor 11.

In the crimped state CS, the left and right crimping pieces 27 are laterally symmetric and one pressing portion 29 is formed at each crimping piece 27. The left and right pressing portions 29 are laterally symmetric. The pressing portions 29 are formed from substantially central positions of the crimping pieces 27 to the front ends of the crimping pieces 27 substantially in forward and backward directions FBD (longitudinal direction of the wire 10) and are inclined with respect to the bottom wall 26 to be sloped downward or inward toward the front. This angle of inclination is substantially constant over the entire lengths of the pressing portions 29. Areas REA of the upper walls 28 of the crimping pieces 27 behind or adjacent to the pressing portions 29 are substantially parallel to the bottom wall 26. The pressing portions 29 are formed substantially only in central parts of the crimping pieces 27 in a width direction WD.

The left and right edges of the upper wall 28 of each crimping piece 27 define folds 30 at the left and right sides of the pressing portion 29. The folds 30 are such that folded parts face and project upward or outward or away from the conductor 11. The heights of the upper end edges of the folds 30 are substantially constant. Although the folds 30 are arranged at four positions spaced apart in the width direction WD, the inner two (i.e. standing end edge portions of the both crimping pieces 27) folds 30 are held in contact and press each other in the width direction WD.

According to this embodiment, the pressing portions 29 are closer to the bottom wall 26 than the rear end areas REA of the crimping pieces 27 are formed at the front ends of the upper walls 28 of the crimping pieces 27 located at the side of the conductor 11 substantially opposite to the bottom wall 26. The conductor 11 is displaced or deformed toward the bottom wall 26 by the pressing portions 29 at the front ends of the upper walls 28 of the crimping pieces 27 Thus, the height of the front end of the conductor 11, projecting from the front end of the wire barrel 25, is suppressed (e.g. as compared to a portion of the conductor 11 corresponding to the upper walls 28, see e.g. FIG. 4). Therefore, even if the front end portion of the conductor 11 is bent up toward the side opposite to the bottom wall 26, the height of the bent-up part is suppressed.

The pressing portions 29 are inclined to approach the bottom wall 26 toward the front. Thus, the front end portion of the conductor 11 also obliquely projects downward toward the front from the wire barrel 25 to approach the bottom wall 26 as can be seen from FIG. 4. Thus, the height of the front end of the conductor 11 can be suppressed more effectively.

The pressing portions 29 are formed into recesses or channels by hammering parts of the upper walls 28 of the crimping pieces 27, excluding the opposite widthwise end portions toward the bottom wall 26, and the widthwise ends of the front ends of the upper walls 28 define folds 30 projecting away from the bottom wall 26. The technical significance of this construction is as follows. If the front end portions of the upper walls 28 of the crimping pieces 27 are deformed over the entire widths to approach the bottom wall 26 upon forming the pressing portions 29, the side walls connecting the upper walls 28 and the bottom wall 26 may be deformed outwardly in the width direction WD by as much as the approach amount of the upper walls 28 toward the bottom wall 26 and the wire barrel portion 25 may be widened. In contrast, in this embodiment, the folds 30 preferably are formed at the opposite widthwise ends of the upper walls 28 and/or only the parts between the folds portions 30 preferably are formed into the pressing portions 29 by being deformed to approach the bottom wall 26. Thus, it is not necessary to displace the side walls connecting the upper walls 28 and the bottom wall 26 outwardly in the width direction, wherefore the widening of the wire barrel portion 25 can be avoided.

The present invention is not limited to the above described and illustrated embodiment. For example, the following embodiments are also included in the technical scope of the present invention.

Although the pressing portions have substantially flat inclined surfaces in the above embodiments, they may have curved surfaces.

Although the pressing portions are inclined to approach the bottom wall toward the front in the above embodiment, they may be in the form of such steps as to approach the bottom wall.

Although the pressing portions are formed by locally recessing the upper walls of the crimping pieces in the width direction in the above embodiment, they may be formed to approach the bottom wall over the entire widths of the upper walls of the crimping pieces.

Although the pressing portions are formed after the wire barrel portion is crimped into connection with the conductor in the above embodiment, they may be formed before the conductor is connected by crimping or may be formed simultaneously with the crimping operation.

What is claimed is:

1. A connection structure (22) for a terminal fitting (20) comprising: a wire barrel (25) with a base wall (26) and two crimping pieces (27) projecting from the base wall (26),
a crimping pieces (27) compressing a conductor (11) of a wire (10) within the wire barrel (25) to electrically connect the conductor (11),
the front end portion of the conductor (11) projecting forward from the front end of the wire barrel (25) in a crimped state (CS), and the crimping pieces (27) having ceiling walls (28) located at a side of the conductor (11) substantially opposite to the base wall (26) at least one pressing portion (29) formed at front end portions of the ceiling walls (28) closer to the base wall (26) then rear end areas (REA) of the crimping pieces (27).

2. The connection structure of claim 1, wherein the pressing portions (29) are inclined to approach the base wall (26) toward the front.

3. The connection structure of claim 2, wherein the angle of inclination of the pressing portions (29) is substantially constant over the entire lengths of the pressing portions (29).

4. The connection structure of claims 1, wherein the pressing portions (29) are formed into recesses by hammering parts of the ceiling walls (28) of the crimping pieces (27) excluding the opposite widthwise ends towards the base wall (26).

5. The connection structure of claim 1 wherein the opposite widthwise ends of the front of the ceiling walls (28) are formed into folds (30) projecting away from the base wall (26).

6. The connection structure of claim 1, wherein the pair of lateral crimping pieces (27) are laterally symmetric.

7. The connection structure of claim 1, wherein the rear end areas (REA) of the crimping pieces (27) behind the pressing portions (29) are substantially parallel to the base wall (26).

8. A wire-terminated conduction path (1) comprising:
a wire (10) having an end, a conductor (11) extending from the end and an insulation coating (12) surrounding the conductor (11) at locations spaced from the end so that the conductor (11) is exposed adjacent to the end; and
a terminal fitting (20) having opposite front and rear ends, the terminal fitting including:
a terminal connecting portion (21) adjacent to the front end and configured for connection with a mating terminal;
a bottom wall (26) extending rearward from the terminal connecting portion (21);
an insulation barrel (31) substantially adjacent to the rear end and integral with the bottom wall (26), the insulation barrel (31) being crimped into connection with the insulation coating (12); and
a wire barrel (25) between the terminal connecting portion (21) and the insulation barrel (31), the wire barrel (25) including first and second crimping pieces (27) extending up from opposite sides of the bottom wall (26), first and second upper walls (28) extending toward one another from parts of the respective first and second crimping pieces (27) spaced from the bottom wall (26) so that the upper walls (28) are opposed to the bottom wall (26) with the conductor (11) crimped between the bottom wall (26) and the upper walls (28), and first and second pressing portions (29) formed on parts of the respective first and second upper walls (28) closest to the terminal connecting portion (21), the pressing portions (29) being sloped down toward the bottom wall (26) at locations closer to the front end and the conductor (11).

9. The wire-terminated conduction path of claim 8, further comprising first and second outer folds (3) on the respective first and second crimping pieces (27) and disposed so that the pressing (portions (29) are between the outer folds (30).

10. The conduction path of claim 9, further comprising wire terminated inner folds (30) adjacent to one another and between the first and second pressing portions (29).

11. The wire-terminated conduction path of claim 8 wherein the angle of inclination of the pressing portions (29) is substantially constant over all of the respective pressing portion (29).

12. The wire-terminated conduction path of claim 8 wherein the pressing portions (29) are formed into recesses.

13. The wire terminated conduction path of claim 8 wherein the crimping pieces (27) are laterally symmetric.

14. The wire-terminated conduction path of claim 8 wherein rear end areas (REA) of the crimping pieces (27) behind the pressing portions (29) are substantially parallel to the base wall (26).

15. A method of connecting a terminal fitting (20) to a wire (10), comprising the following steps:
providing a connection structure (22) including a wire barrel (25) in the form of at least one open barrel, in which two crimping pieces (27) project from a base wall (26),
at least partly exposing a conductor (11) of a wire (10),
placing the wire (10) on the base wall (26) so that the exposed conductor (11) is between the crimping pieces (27),
deforming the crimping pieces (27) to at least partly surround and compress the conductor (11) while allowing a front end of the conductor (11) to project forward from the wire barrel (25) in a crimped state (CS), and
deforming a front end portion of each crimping piece (27) to form pressing portions (29) that urge the front end portion of the conductor (11) toward the base wall (26).

16. The connection method of claim 15, wherein the pressing portions (29) are formed so that angles of inclination of the pressing portions (29) are substantially constant along all of the pressing portions (29).

17. The connection method of claim 15, wherein the pressing portions (29) are formed into recesses by hammering toward the base wall (26) parts of the crimping pieces (27) spaced inwardly from opposite widthwise end portions toward the base wall (26).

18. The connection method of claim 15, further comprising forming folds (30) at the wire barrel (25) so that the folds (30) project toward a side substantially opposite to the base wall (26).
